(19) United States
(12) Patent Application Publication
(10) Pub. No.: US 2003/0009471 A1
(43) Pub. Date: Jan. 9, 2003

(54) Semiconductor intellectual property distribution system and semiconductor intellectual property distribution method

(76) Inventor: Takeshi Hashizume, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/162,081

(22) Filed: Jun. 5, 2002

(30) Foreign Application Priority Data
Jul. 6, 2001 (JP) 2001-206797

(51) Int. Cl. G06F 7/00

(52) U.S. Cl. 707/100

(57) ABSTRACT

A semiconductor intellectual property distribution system includes a registration IP database in which an IP specification of IP is registered, a required IP database storing a required IP specification, a master database storing design information defined by the IP specification and the required IP specification, an evaluation database storing evaluation information related to the registered IP, and a public database storing IP information and the required IP specification that can be made public. When the IP user uses the IP, the semiconductor manufacturer returns a portion of the IP usage charge collected from the IP user.

### BACKGROUND OF THE INVENTION

1. Field of the Invention

The present invention generally relates to semiconductor intellectual property distribution systems and a semiconductor intellectual property distribution method and, more particularly to a semiconductor intellectual property distribution system and a semiconductor intellectual property distribution method for distributing intellectual property used in a semiconductor chip.

2. Description of the Related Art

In recent years, as the scale of integrated circuit devices grow larger and the product lifetime is shortened, existing intellectual property (hereinafter, simply referred to as IP) is used extensively in designing integrated circuit devices. Since it is often difficult for a single manufacturer to develop the entirety of a system LSI, a system LSI is usually designed using IP supplied from a designing company or the like specializing in IP.

FIG. 21 shows a semiconductor intellectual property distribution system according to the related art. Referring to FIG. 21, numerals 1a, 1b and 1c indicate IP creators creating IP, 2a, 2b and 2c indicate IP users who design and develop a semiconductor chip using the IP created by the IP creators 1a, 1b and 1c, and 3 indicates a semiconductor manufacturer manufacturing a semiconductor chip designed and developed by the users 2a, 2b and 2c.

A description will now be given of the operation according to the related art.

Every time the IP users 2a, 2b and 2c receives a supply of IP from a plurality of IP creators 1a, 1b and 1c, they conclude a license agreement with the IP creators 1a, 1b and 1c for the use of IP. The IP creators 1a, 1b and 1c supply the same IP to a plurality of IP creators 2a, 2b and 2c and provide the same maintenance and support service to a large number of IP users 2a, 2b and 2c.

The IP creators 1a, 1b and 1c are often companies specializing in the production of IP and are entities separate from the semiconductor manufacturer 3. Therefore, it is difficult for the IP creators 1a, 1b and 1c to prove a record of performance or guarantee the actual performance on silicon. The IP creators 1a, 1b and 1c may commission the semiconductor manufacturer 3 to produce a test chip in which the custom IP is built and evaluate the IP for performance. It is difficult, however, for such an effort of evaluation to provide verifiable data related to yield in production, since the test chip is not mass-produced. Often, the evaluating environment is not sufficiently proper to enable the IP creators 1a, 1b and 1c to verify the mass-production scale field performance.

In a case in which the IP creators 1a, 1b and 1c are also the IP users 2a, 2b and 2c that mass-produced a semiconductor chip in which IP is built, it is possible to supply IP in which the aforementioned problems are resolved. However, the IP users 2a, 2b and 2c who need the IP are often competitors. As a result, distribution of IP is generally confined to the same company.

Since the semiconductor intellectual property distribution system is constructed as described, it has a disadvantage in that it is difficult to promote the distribution of IP.

Because the IP creators 1a, 1b, 1c and the IP users 2a, 2b, 2c need to conclude a license deal regarding the use of IP on a multiple-to-multiple basis, use of IP requires a relatively complex procedure.

The IP creators 1a, 1b and 1c are often companies specializing in the production of IP and are entities separate from the semiconductor manufacturer 3. For this reason, it is difficult for the IP creators 1a, 1b and 1c to prove a record of performance of IP or guarantee the actual performance thereof on silicon. This has a disadvantage of preventing the IP users 2a, 2b and 2c from using IP in a carefree manner.

Still another disadvantage is that the IP creators 1a, 1b and 1c need to provide the same maintenance and support service to a plurality of IP users 2a, 2b and 2c, thereby increasing the support cost.

### SUMMARY OF THE INVENTION

Accordingly, a general object of the present invention is to provide a semiconductor intellectual property distribution system and a semiconductor intellectual property distribution method in which the aforementioned problems and disadvantages are eliminated.

Another and more specific object is to provide a semiconductor intellectual property distribution system and a semiconductor intellectual property distribution method in which there is need for the IP creators and the IP users to conclude a license agreement on a multiple-to-multiple basis.

Still another object is to provide a semiconductor intellectual property distribution system and a semiconductor intellectual property distribution method in which the IP users can use IP in a carefree manner.

Yet another object is to provide a semiconductor intellectual property distribution system and a semiconductor intellectual property distribution method in which the cost for maintenance and support incurred by the IP creators is reduced.

The aforementioned objects can be achieved by a semiconductor intellectual property distribution system allowing a semiconductor manufacturer to register and manage intellectual property (IP) created by an IP creator and disclosing the registered and managed IP to an IP user engaged in designing and developing of a semiconductor chip using the IP, comprising: a registration IP database registering an IP specification of the IP created by the IP creator; a required IP registration database registering a required IP specification requested by the IP user; a master database managing and storing an entirety of design information defined by the IP specification registered in the registration IP database and the required IP specification registered in the required IP registration database, an evaluation database storing evaluation information related to the registered IP; a first public database storing IP information and the required IP specification made available to the IP creator or the IP user, selected from the design information stored in the master database and the evaluation stored in the evaluation database, wherein the semiconductor manufacturer returns a part of an IP usage charge collected from the IP user to the IP creator, when the IP stored in the first public database is used by the IP user.

An identity of the IP creator, information on a semiconductor chip in which the created IP is built, and a portion of information related to creation and quality of the IP may not be disclosed in accordance with designation by the IP creator registering the IP specification of the created IP in the registration IP database.

The IP usage charge collected by the semiconductor manufacturer from the IP user may include an initial IP usage charge incurred at an initial stage of semiconductor chip development by the IP user.

In a case where the IP creator designs and develops a semiconductor chip using the IP of its own creation and commissions the semiconductor manufacturer to manufacture a prototype of the semiconductor chip and mass-produce the semiconductor chip, the semiconductor manufacturer may deduce the IP usage charge returned to the IP creator via the IP user less a chip prototype manufacturing cost and a mass-production chip manufacturing cost and collect a resultant charge from the IP creator.

In a case where the IP user designs and develops a semiconductor chip using the IP and commissions the semiconductor manufacturer to manufacture a prototype of the semiconductor chip and mass-produce the semiconductor chip, the semiconductor manufacturer may add a chip prototype manufacturing cost and a mass-production chip manufacturing cost to the IP usage charge and collect a resultant charge from the IP user.

The semiconductor intellectual property distribution system may further comprise a second public database for the IP user, the second public database for the IP user storing the IP information related an external specification selected from the IP information stored in the first public database, and the second public database for the IP user being accessed by the IP user.

The public database for the IP user may enable the external specification to be downloaded instantaneously responsive to an instruction from the IP user.

The semiconductor intellectual property distribution system may further comprise a second public database for the IP creator, the second public database for the IP creator storing the required IP specification selected from the required IP specification stored in the first public database, and the second public database being accessed by the IP user.

In the first public database, an identity of the registering IP creator, and information, registered by the IP creator, related to a semiconductor chip in which the IP is built, may not be disclosed, while IP usage record is disclosed.

An identity of the registering IP user, and information, registered by the IP user, related to a semiconductor chip in which the IP is built, may not be disclosed in the first public database.

Layout information, based on which the IP is analyzable, may be excluded from storage in the first public database.

The semiconductor intellectual property distribution system may further comprise a design apparatus for producing complete design data on a semiconductor chip, by combining user design data transferred from the IP user having built the IP, not including the layout information, in the semiconductor chip, and the layout information managed by the semiconductor manufacturer.

The design apparatus may inspect the complete design data using an inspection tool, based on a control file transferred from the IP user with the use design data and describing option settings and procedure of execution to be referred to in executing an inspection, and the design apparatus may further transfer a portion or an entirety of inspection data obtained as a result of inspection to the IP user.

The semiconductor intellectual property distribution system may further comprise a support database accepting an inquiry as to lack or malfunction of the IP information placed by the IP user, wherein the semiconductor manufacturer refers to the support database so as to perform necessary actions responsive to lack or malfunction of the IP information.

The semiconductor manufacturer may collect from the IP user a support fee consistent with a level of support responsive to the lack or malfunction of the IP information.

The semiconductor intellectual property distribution system may further comprise a support database accepting an inquiry as to lack or malfunction of the IP information placed by the IP user, wherein the semiconductor manufacturer refers to the support database and instructs the IP creator to perform necessary actions responsive the lack or malfunction of IP information inquired of.

The semiconductor manufacturer may collect from the IP user a support fee consistent with a level of support responsive to the lack or malfunction of the IP information and return the support fee to the IP creator.

In the first public database, a plurality of IP sets of a same type may be graded so that a ranking is made available to the IP user.

The plurality of IP sets of the same type may be graded in accordance with a price at the time of using the IP so that a ranking is made available to the IP user.

The semiconductor intellectual property distribution system may further comprise a search engine for searching the IP information or the required IP specification stored in the first public database.

The aforementioned objects can also be achieved by a semiconductor intellectual properly distribution method comprising the step of: acquiring IP information from a public database storing IP information selected from design information stored in a master database and from evaluation stored in an evaluation database, the master database managing and storing an entirety of design information defined by an IP specification registered by an IP creator in a registration IP database and a required IP specification registered by an IP user in a required IP registration database, and the evaluation database storing evaluation information related to the design information and provided by a semiconductor manufacturer, wherein the IP user pays a usage charge to the semiconductor manufacturer for the use of the IP information as a result of designing a semiconductor, and the semiconductor manufacturer returns a part of the usage charge to the IP creator.

### BRIEF DESCRIPTION OF THE DRAWINGS

Other objects and further features of the present invention will be apparent from the following detailed description when read in conjunction with the accompanying drawings, in which:

FIG. 1 is a semiconductor intellectual property distribution system according to a first embodiment of the present invention;

FIG. 2 shows a on screen display presented when an IP specification is registered in a registration IPSDB according to a second embodiment;

FIG. 3 is a semiconductor intellectual property distribution system according to a third embodiment of the present invention;

FIG. 4 is a semiconductor intellectual property distribution system according to a fourth embodiment of the present invention;

FIG. 5 is a semiconductor intellectual property distribution system according to a fifth embodiment of the present invention;

FIG. 6 is a semiconductor intellectual property distribution system according to a sixth embodiment of the present invention;

FIG. 7 is a semiconductor intellectual property distribution system according to a seventh embodiment of the present invention;

FIG. 8 shows a on-screen display presented when IP information related to an IP specification stored in a public IPDB is referred to according to an eighth embodiment of the present invention;

FIG. 9 shows a on-screen display presented when IP information related to an IP specification stored in a public IPDB is referred to according to a ninth embodiment of the present invention;

FIG. 10 shows a on-screen display presented when IP information related to an IP specification stored in a public IPDB is referred to according to a tenth embodiment of the present invention;

FIG. 11 is a semiconductor intellectual property distribution system according to a twelfth embodiment of the present invention;

FIG. 12 is a semiconductor intellectual property distribution system according to a thirteenth embodiment of the present invention;

FIG. 13 is a semiconductor intellectual property distribution system according to a fourteenth embodiment of the present invention;

FIG. 14 is a semiconductor intellectual property distribution system according to a fifteenth embodiment of the present invention;

FIG. 15 shows a on-screen display presented when IP information related to an IP specification stored in a public IPDB is referred to according to a sixteenth embodiment of the present invention;

FIG. 16 shows a on-screen display presented when IP information related to an IP specification stored in a public IPDB is referred to according to a seventeenth embodiment of the present invention;

FIG. 17 is a semiconductor intellectual property distribution system according to an eighteenth embodiment of the present invention;

FIG. 18 is a semiconductor intellectual property distribution system according to a nineteenth embodiment of the present invention;

FIG. 19 is a semiconductor intellectual property distribution system according to a twelfth embodiment of the present invention;

FIG. 20 is a semiconductor intellectual property distribution system according to a twenty-first embodiment of the present invention; and

FIG. 21 shows a semiconductor intellectual property distribution system according to the related art.

### DESCRIPTION OF THE PREFERRED EMBODIMENTS

First Embodiment

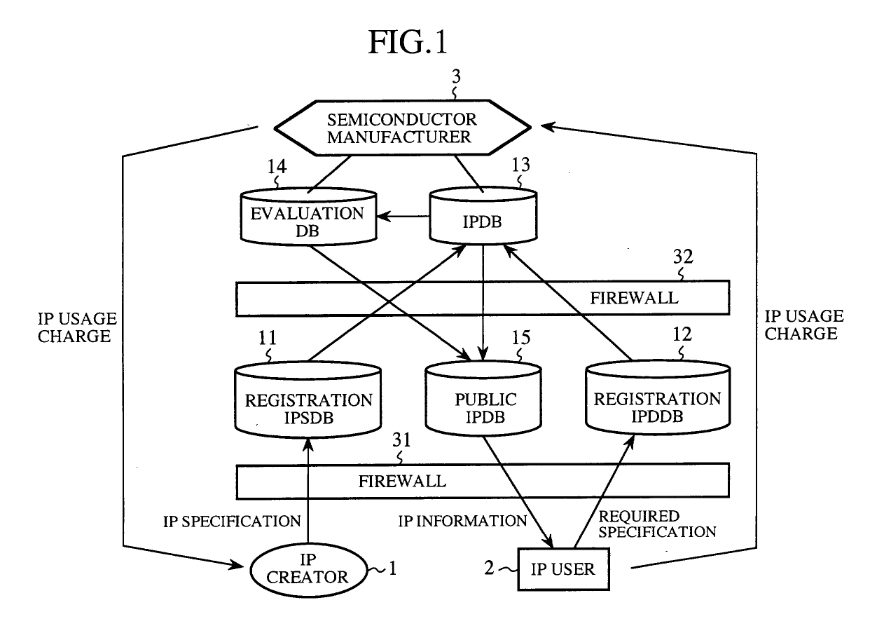

FIG. 1 is a semiconductor intellectual property distribution system according to a first embodiment of the present invention.

Referring to FIG. 1, the semiconductor intellectual property distribution system according to the first embodiment includes an IP creator 1 creating IP, an IP user 2 designing and developing a semiconductor chip using the IP created by the IP creator 1, and a semiconductor manufacturer 3 registering and managing the IP created by the IP creator 1 and make the IP publicly available to the IP user 2.

The system also includes an IP registration database (hereinafter, referred to as registration IPSDB) 11 that stores IP specifications for the IP created by the IP creator 1, a required IP registration database (hereinafter, referred to as registration IPDDB) 12 that stores required specifications for the IP required by the IP user 2, a master database (hereinafter, referred to as IPDB) 13 that stores and manages all the design information defined by the IP specifications registered in the registration IPSDB 11 and the required IP specifications registered in the registration IPDDB 12. The system further includes an evaluation database (hereinafter, referred to as evaluation DB) 14 that stores evaluation information, tracked operation information, and production information related to the registered IP and provided by the semiconductor manufacturer 3, and a public database (hereinafter, referred to as public IPDB or a first public database) 15 that stores publicly viewable IP information and required IP specifications selected from the design information stored in the IPDB 13 and the information stored in the evaluation DB 14.

The registration IPSDB 11, the registration IPDDB 12, the IPDB 13, the evaluation DB 14 and the public IPDB 15 are installed, for example, at the semiconductor manufacturer 3. The databases may be managed by a data management vendor commissioned by the semiconductor manufacturer 3 for maintenance and management. Referring again to FIG. 1, numeral 31 indicates a firewall that prohibits access from those other than registered users, and 32 indicates a firewall that prohibits access from those other than authorized persons in the semiconductor manufacturer 3.

A description will now be given of the operation according to the first embodiment.

The IP creator 1 registers a specification of IP of its own creation in the registration IPSDB 11 and concludes a license agreement with the semiconductor manufacturer 3. The IP user 2 registers the required IP specification in the registration IPDDB 12 and concludes al license agreement with the semiconductor manufacturer 3. The IP specification registered in the registration IPSDB 11 and the required IP specification registered in the registration IPDDB 12 are stored in the IPDB 12 as design information. The semiconductor manufacturer 3 evaluates the IP stored in the IPDB 13 by examining the data or by creating a prototype and testing it on silicon. The evaluation information, the tracked operation information and the production information are stored in the evaluation DB 14.

The information selected from the design information stored in the IPDB 13 and the information stored in the evaluation DB 14 for public view is stored in the public IPDB 15. The IP user 2 accesses the public IPDB 15 so as to make the IP information related to the required specification of the required IP. The IP user 2 uses the information for design and development of a semiconductor chip. The IP user 2 pays an IP usage charge for the use of the registered IP to the semiconductor manufacturer 3. The semiconductor manufacturer 3 returns a part of the IP usage charge thus collected to the IP creator 1.

Thus, according to the first embodiment, the IP creator 1 is able to promote the distribution of IP of its own creation, by providing the IP to a large number of IP users 2 via the public IPDB 15 managed by the semiconductor manufacturer 3.

In further accordance with the first embodiment, the IP creators 1 and the IP users 2 conclude a usage agreement regarding the use of IP only with the semiconductor manufacturer. Thereby, the trouble of having to conclude a license agreement between multiple parties is eliminated.

In still further accordance with the first embodiment, the IP user 2 is capable of obtaining the IP evaluated by the semiconductor manufacturer 3. Therefore, the IP user 2 can use the IP in a carefree manner.

Second Embodiment

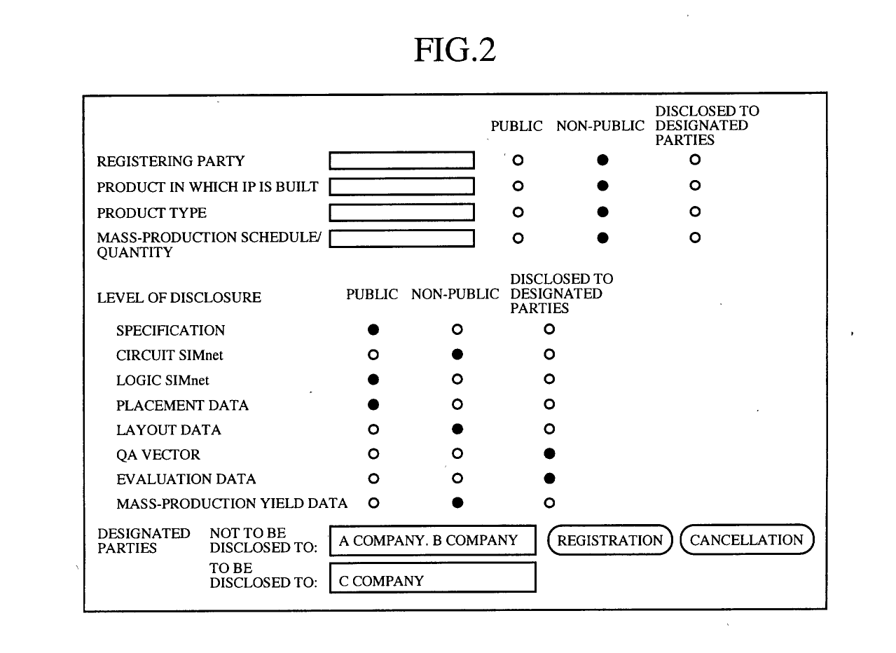

The construction of the semiconductor intellectual property distribution system according to a second embodiment is the same as that of the first embodiment shown in FIG. 1. FIG. 2 shows a on-screen display presented when an IP specification of IP created by the IP creator 1 is registered in a registration IPSDB.

A description will now be given of the operation according to the second embodiment.

When registering the IP specification related to the IP of its own creation, the IP creator 1 can withhold from public view selected information related to the IP creator 1 and the product in which the IP is built. As shown in FIG. 2, the IP creator 1 may choose not to disclose the registering party (IP creator 1), the product in which the IP is built, the product type and the mass-production schedule/quantity. The IP creator 1 may also choose not to disclose a part of the information related to the creation of IP and a part of the information related to the performance and quality of IP. For example, the IP creator 1 may choose not to disclose information selected from the circuit simulation net list (circuit SIMnet), the layout data, the inspection pattern (QA vector), the evaluation data and the mass-production yield data. Designation of nondisclosure may also be associated with designated parties. The other aspects of the operation are the same as the corresponding aspects of the first embodiment.

By allowing the IP creator 1 to designate non-disclosure as shown in FIG. 2, the public IPDB 15 stores only the IP information selected for public view. By allowing designation of the registering party as non-disclosed information, it is ensured that the IP user 2 accesses the IP creator 1 directly. By allowing designation of non-disclosure of a part of the information related to the production of IP and a part of the information related to the performance and quality of IP, secret information related to IP is prevented from being leaked to competitors.

Thus, according to the second embodiment, the same advantages available in the first embodiment are also available. In addition, by allowing the IP creator 1 to designate nondisclosure of a part of the IP information at registration, the IP creator 1 is enabled to prevent leakage of the secret information of the registered IP. At the same time, distribution of IP to those IP users 2 that are also competitors is promoted.

Third Embodiment

FIG. 3 is a semiconductor intellectual property distribution system according to a third embodiment of the present invention. Referring to FIG. 3, a cost database (hereinafter, referred to as cost DB) 16 keeps a record of the IP usage charge collected from the IP user 2 and is maintained by the semiconductor manufacturer 3. The IP usage charge recorded includes an initial usage charge collected from the IP user 2 at the development stage of a semiconductor chip and the mass-production IP usage charge collected in accordance with the level of usage of IP in manufacturing a semiconductor chip carrying the IP. The other aspects of the construction are the same as the corresponding aspects of the first embodiment shown in FIG. 1.

A description will now be given of the operation according to the second embodiment.

When the IP user registers the level of usage of IP in manufacturing a semiconductor chip in the registration IPDDB 12, the registered IP usage level is reflected in the IPDB 13. The semiconductor manufacturer 3 records in the cost DB 16 the initial IP usage charge incurred by the IP user 2 and kept track of by the semiconductor manufacturer 3, and records the mass-production IP usage charge commensurate with the IP usage level in the cost DB 16. The semiconductor manufacturer 3 collects the initial IP usage charge and the mass-production IP usage charge recorded in the cost DB 16 from the IP user 2 and returns a portion of the collected charge to the IP creator 1. The other aspects of the third embodiment are the same as the corresponding aspects of the first embodiment.

As described, according to the third embodiment, the same advantages available in the first embodiment are also available. In addition, by allowing the semiconductor manufacturer 3 to collect the initial IP usage charge in addition to the mass-production IP usage charge, the semiconductor manufacturer 3 is capable of collecting the IP usage charge and returns a portion thereof to the IP creator 1 even if the IP user 2 does not mass-produce a semiconductor chip in which the IP is built.

Fourth Embodiment

FIG. 4 is a semiconductor intellectual property distribution system according to a fourth embodiment of the present invention. Referring to FIG. 4, the semiconductor intellectual property distribution system comprises a cost database (hereinafter, referred to as cost DB) 17 managed by the semiconductor manufacturer 3 and recording the IP usage charge collected from the IP user 2, and a chip prototype manufacturing cost and a chip manufacturing cost collected from the IP creator 1. The other aspects of the construction according to the fourth embodiment are the same as the corresponding aspects of the third embodiment shown in FIG. 3. In the fourth embodiment, the IP creator 1 registers IP of its own creation, and designs and develops a semiconductor chip using the IP of its own creation. The semiconductor manufacturer 3 manufactures a prototype and mass-produces the chip. The IP creator 1 uses the mass-produced semiconductor chip. The IP user 2 uses the same IP registered.

A description will now be given of the operation according to the fourth embodiment.

The IP usage charge commensurate with the level of use of IP by the IP user 2 is recorded in the cost DB 16 in a similar configuration as the third embodiment. A portion of the IP usage charge is recorded in the cost DB 17. The semiconductor manufacturer 3 records the prototype chip manufacturing cost and the mass-production chip manufacturing cost incurred by the IP creator 1 in the cost DB 17. The cost recorded in the cost DB 17 comprises the chip prototype manufacturing cost+the chip manufacturing cost−IP usage charge. This enables the semiconductor manufacturer 3 to collect the chip prototype manufacturing cost+the chip manufacturing cost−IP usage charge recorded in the cost DB 17.

In a case in which a semiconductor chip has already been manufactured, the semiconductor manufacturer 3 deduct the IP usage charge less the forthcoming chip prototype manufacturing cost and chip manufacturing cost incurred by the IP creator 1 so that the amount after deduction is charged to the IP creator 1. Alternatively, the IP usage charge may separately returned to the IP creator 1. The other aspects of the fourth embodiment are the same as the corresponding aspects of the first embodiment.

As described, according to the fourth embodiment, the same advantages available in the first embodiment are also available. In addition, the IP creator 1 gains deduction of the IP usage charge derived from the use of IP by the IP creator 2 less the chip prototype manufacturing cost and chip manufacturing cost incurred as a result development and manufacturing of a semiconductor chip. With this, the competitive edge of the IP creator 1 is enhanced. By allowing the semiconductor manufacturer 3 to managed the IP usage charge incurred by the IP creator 2 using the same IP, the IP creator 1 is capable of collecting a fair IP usage charge consistent with the usage record.

Fifth Embodiment

FIG. 5 is a semiconductor intellectual property distribution system according to a fifth embodiment of the present invention.

Referring to FIG. 5, a cost database (hereinafter, referred to as cost DB) 18 is managed by the semiconductor manufacturer 3 and recording a chip prototype manufacturing cost, a chip manufacturing cost and an IP usage charge collected from the IP user 2. The other aspects of the construction are the same as the corresponding aspects of the first embodiment shown in FIG. 1. In this embodiment, the IP user 2 uses registered IP to design and develop a semiconductor chip. The semiconductor manufacturer 3 manufactures a prototype of semiconductor chip thus designed and developed. The IP creator 1 uses the mass-produced semiconductor chip.

A description will now be given of the operation according to the fifth embodiment.

The semiconductor manufacturer 3 records in the cost DB 18 the chip prototype manufacturing cost, the chip manufacturing cost and the IP usage charge collected from the IP user 2. The costs recorded in the cost DB 18 comprises the chip prototype manufacturing cost+chip manufacturing cost+IP usage charge. The fee associated with the total cost is collected from the IP user 2. The semiconductor manufacturer 3 returns a portion of the IP usage charge collected to the IP creator 1. The IP usage charge includes an initial usage charge and a mass-production IP usage charge. The usage record referred to in calculating the mass-production IP usage charge is kept track of according to the third embodiment. The other aspects of the operation according t the fifth embodiment are the same as corresponding aspects of the first embodiment.

As described, according to the fifth embodiment, the same advantages available in the first embodiment are also available. In addition, the IP user 2, being a customer of the semiconductor manufacturer 3 by using the semiconductor chip manufactured by the semiconductor manufacturer 3, the IP user 2 can put on negotiation the totality of the chip prototype manufacturing cost, the chip manufacturing cost and the IP usage charge. The IP user 2 can use this arrangement to its own advantage in price negotiation with the semiconductor manufacturer 3.

Sixth Embodiment

FIG. 6 is a semiconductor intellectual property distribution system according to a sixth embodiment of the present invention. Referring to FIG. 6, an IP user 2a accesses the system via the Internet 33, and a public database (hereinafter, referred to as second public DB) 19 is managed by the semiconductor manufacturer 3 and records IP information related to external specification and selected from the IP information stored in the public IPDB 15. The other aspects of the construction of the sixth embodiment are the same as the corresponding aspects of the first embodiment shown in FIG. 1.

A description will now be given of the operation according to the sixth embodiment.

Of the IP information stored in the public IPDB 15, IP information related to external specification is stored in the public DB 19. The IP user 2a accesses the public DB 19 via the Internet 33 so as to obtain IP information related to external specification. The other aspects of the operation according to the sixth embodiment are the same as the corresponding aspects of the first embodiment shown in FIG. 1.

As described, according to the sixth embodiment, the same advantages available in the first embodiment are also available. In addition, the IP user 2a refers to the registered IP information via the Internet 33, it is easy to obtain the IP information that satisfies the specification of a semiconductor chip expected to be designed. By making the registered IP information widely available, the IP creator 1 can increase the number of customers.

Seventh Embodiment

FIG. 7 is a semiconductor intellectual property distribution system according to a seventh embodiment of the present invention. Referring to FIG. 7, the IP creator 1a accesses the system via the Internet 33 and a public database (hereinafter, referred to as public DB, second public database) 20 is managed by the semiconductor manufacturer 3 and records a part of the required IP specification stored in the public IPDB 15. The other aspects of the construction according to the seventh embodiment are the same as the corresponding aspects of the first embodiment.

A description will now be given of the operation according to the seventh embodiment.

A part of the required IP specification stored in the public IPDB 15 is stored in the public DB 20. The IP creator 1a accesses the public DB 20 via the Internet 33 sQ as to obtain the required IP specification. The other aspects of the operation according to the seventh embodiment are the same as the corresponding aspects of the first embodiment.

As described, according to the seventh embodiment, the same advantages available in the first embodiment are also available. In addition, the IP creator 1a can refer to the registered required IP specification via the Internet 33 so as to easily inform itself of the IP specification requested by the IP user 2. By making the registered required IP specification widely known, the manufacturer 3 can secure access to an increased volume of IP.

Eighth Embodiment

The construction of the semiconductor intellectual property distribution system according to an eighth embodiment is the same as the corresponding construction of the first embodiment. FIG. 8 shows a on-screen display presented when IP information related to an IP specification stored in a public IPDB is referred to according to an eighth embodiment of the present invention.

A description will now be given of the operation according to the eighth embodiment.

When the IP creator 2 having completed a user registration in the registration IPSDB 12 accesses the public IPDB 15, IP information related to a required IP specification is displayed as shown in FIG. 8. As shown in FIG. 8, the identity of registering party (IP creator 1) and information relating to a semiconductor chip in which IP is built are not disclosed. However, information on IP usage record is disclosed. The history of reference by the IP user 2 to the IP specification is recorded in the public IPDB 15. The other aspects of the operation according to the first embodiment are the same as the corresponding aspects of the eighth embodiment.

As described, according to the eighth embodiment, the same advantages available in the first embodiment are also available. In addition, since the identity of a registering party (IP creator 1) and information relating to a semiconductor chip in which IP is built are not disclosed, IP information can be made available to a broad spectrum of IP users 2 including competitors so that distribution of IP is promoted. Further, by disclosing the IP usage record to the IP user 2, the IP user 2 can verify the record of operation on silicon and use the registered IP in a carefree manner.

Ninth Embodiment

The construction of the semiconductor intellectual property distribution system according to a ninth embodiment is the same as the construction of the system according to the first embodiment shown in FIG. 1.

FIG. 9 shows a on-screen display presented when IP information related to an IP specification stored in a public IPDB is referred to according to a ninth embodiment of the present invention.

A description of the operation according to the ninth embodiment will now be described.

When the IP creator 1 having completed a user registration in the registration IPSDB 11 accesses the public IPDB 15, IP information related to a required IP specification is displayed as shown in FIG. 9. As shown in FIG. 9, the identity of registering party (IP user 2) and information relating to a semiconductor chip in which IP is built are not disclosed. Referring to FIG. 9, RTL indicates design data prepared using a hardware description language, circuit Sim and logic Sim indicate design data necessary for circuit simulation and logic simulation, respectively. The history of reference by the IP creator 1 to the required IP specification is recorded in the public IPDB 15. The other aspects of the operation are the same as the corresponding aspects of the first embodiment.

As described, according to the ninth embodiment, the same advantages available to the first embodiment are also available. In addition, since the identity of a registering party (IP user 2) and information relating to a semiconductor chip in which IP is built are not disclosed, a required IP specification can be made available to a broad spectrum of IP creators 1 including competitors. When the IP creator 1 register IP frequently requested, distribution of IP is promoted.

Tenth Embodiment

The construction of the semiconductor intellectual property distribution system according to a tenth embodiment is the same as that of the sixth embodiment shown in FIG. 6. FIG. 10 shows a on-screen display presented when the IP user 2a refers to IP information related to an IP specification stored in the public DB 19 according to a tenth embodiment of the present invention.

A description will now be given of the operation according to the tenth embodiment.

When the IP user-2a accesses the public DB 19, the IP information related to the required IP specification is displayed on-screen as shown in FIG. 10. As shown in FIG. 10, only the external specification is made immediately available to public. By clicking on the [get] button, the IP user 2a can download the external specification free of charge. The history of reference to the IP information by the IP user 2a is recorded in the public DB 19. The IP user 2a wishing to obtain a specification other than the external specification needs to pay the initial IP usage charge. The other aspects of the tenth embodiment are the same as those of the first embodiment.

As described, according to the tenth embodiment, the same advantages available in the first embodiment are also available. In addition, since the IP user 2a is capable of immediately obtaining an external specification of IP via the Internet, the period required for development of a semiconductor chip is reduced. By charging an initial IP usage charge for the use of IP. information other than the external specification, collection of the IP usage charge is facilitated.

Eleventh Embodiment

The construction of the semiconductor intellectual property distribution system according to an eleventh embodiment is the same as that of the first embodiment.

A description will now be given of the operation according to the eleventh embodiment.

The design information excluding the layout information, based on which the IP could be analyzed, is stored in the public IPDB 15 available for use by the IP user 2. For example, the layout information may be GDSII data or layout versus schematic (LVS) circuit information for inspection purpose, the LVS circuit information being used for verification of a match between the layout data and the circuit information. The other aspects of the operation are the same as the corresponding aspects of the first embodiment.

As described, according to the eleventh embodiment, the same advantages that are available in the first embodiment are also available. In addition, since the layout information is not disclosed to the IP user 2, it is difficult for the IP user 2 to analyze the obtained IP or for the other semiconductor manufacturers to use the IP. By allowing the IP creator 1 to manage information disclosed to the IP user 2, distribution of IP is promoted.

Twelfth Embodiment

FIG. 11 is a semiconductor intellectual property distribution system according to a twelfth embodiment of the present invention. Referring to FIG. 11, a support database (hereinafter, referred to as support DB) 12 is managed by the semiconductor manufacturer 3 and accepting inquiries as to lack or malfunction of IP information placed by the IP user 2. The other aspects of the construction of the twelfth embodiment are the same as the corresponding aspects of the first embodiment shown in FIG. 1.

A description will now be given of the operation according to the eleventh embodiment.

When the IP user 2 accessing the public IPDB 15 for IP information and designing and developing a semiconductor chip finds lack or malfunction of IP information, the IP user 2 places an inquiry as to the lack or malfunction of IP information in the support DB 21. The semiconductor manufacturer 3 refers to the support DB 21 and performs necessary actions to remedy the lack or malfunction of IP information. The semiconductor manufacturer 3 also gives an answer via the support DB 21 and updates the design information in the IPDB 13 or the IP information in the public IPDB 15 as required. The other aspects of the operation are the same as the corresponding aspects of the first embodiment.

As described, according to the twelfth embodiment, the same advantages available in the first embodiment are also available. In addition, the IP user 2 encountering the lack or malfunction of IP information necessary in designing and developing a semiconductor chip is provided with means to place an inquiry with the semiconductor manufacturer 3 and obtain an answer. Accordingly, the semiconductor chip is efficiently designed and developed. The semiconductor manufacturer 3 is capable of tracking the lack or malfunction of registered IP information and quickly responding to the maintenance requirement.

Thirteenth Embodiment

FIG. 12 is a semiconductor intellectual property distribution system according to a thirteenth embodiment of the present invention. The construction shown in FIG. 12 is the same as that of the twelfth embodiment shown in FIG. 11 except that, in the thirteenth embodiment, the IP creator 1 responds to the inquiry as to the lack or malfunction of IP information placed by the IP user 2 by performing necessary actions and giving necessary answers.

A description will now be given of the operation according to the thirteenth embodiment.

When the IP user 2 places an inquiry as to lack or malfunction of the currently used IP information in the support DB 21, the semiconductor manufacturer 3 refers to the support DB 21 and instructs the IP creator to perform necessary actions responsive to the lack or malfunction of IP information specified in the inquiry.

The IP creator 1 performs maintenance of the registered IP and gives an answer to the inquiry to the semiconductor manufacturer 3 via the support DB 21. The IP creator 1 may also add an IP specification or registers the modification in the registration IPSDB 11 as required. The semiconductor manufacturer 3 acknowledges the answer given by the IP creator 1 and routes the answer to the IP user 2 via the support DB 21. The other aspects of the thirteenth embodiment are the same as the corresponding aspects of the first embodiment.

As described, according to the thirteenth embodiment, the same advantages available in the first embodiment are also available. In addition, the IP creator 1 is capable of acknowledging lack or malfunction of registered IP information and quickly responds to a maintenance requirement. Accordingly, the integrity of registered IP is improved so that distribution of registered IP is promoted.

In further accordance with the thirteenth embodiment, the IP creator 1 need only perform maintenance of IP information managed by the semiconductor manufacturer 3 as lack or malfunction of registered IP information comes to light. The IP creator 1 need not perform-maintenance for each IP user 2 using the same IP.

Therefore, the cost of maintenance is reduced.

Fourteenth Embodiment

FIG. 13 is a semiconductor intellectual property distribution system according to a fourteenth embodiment of the present invention. Referring to FIG. 13, a cost database (hereinafter, referred to as cost DB) 22 is managed by the semiconductor manufacturer 3 and records the IP usage charge collected from the IP user 2 and the support cost. The other aspects of the construction of the fourteenth embodiment are the same as the corresponding aspects of the twelfth embodiment shown in FIG. 11.

A description will now be given of the operation according to the fourteenth embodiment.

When the semiconductor manufacturer 3 performs necessary actions responsive to an inquiry as to lack or malfunction of IP information placed by the IP user 2 and gives an answer to the IP user 2, the semiconductor manufacturer 3 records the IP usage charge collected from the IP user 2 and the support cost consistent with the level of support in the cost DB 22. The information recorded in the cost DB 22 provides a basis for billing the IP user 2 for the IP usage charge and support fee. The other aspects of the operation of the fourteenth embodiment are the same as the corresponding aspects of the first embodiment.

As described, according to the fourteenth embodiment, the same advantages available in the first embodiment are also available. In addition, the semiconductor manufacturer 3 is provided with means to collect a support fee from the IP user 2 consistent with the level of support.

Fifteenth Embodiment

FIG. 14 is a semiconductor intellectual property distribution system according to a fifteenth embodiment of the present invention. Referring to FIG. 14, the cost DB 22 is the same as the cost DB 22 of the fourteenth embodiment shown in FIG. 13. A cost database 23 is managed by the semiconductor manufacturer 3 and records the IP charge and support fee to be returned to the IP creator 1. The other aspects of the fifteenth embodiment are the same as the corresponding aspects of the thirteenth embodiment shown in FIG. 12.

A description will now be given of the operation according to the fifteenth embodiment.

When the IP creator 1 performs necessary actions responsive to an inquiry as to lack or malfunction of IP information and gives an answer to the IP user 2, the semiconductor manufacturer 3 records the IP usage charge to be collected from the IP user 2 and the support cost consistent with the level of support in the cost DB 22. The semiconductor manufacturer 3 also records the IP usage charge and the support fee consistent with the level of support to be returned to the IP creator 1. The charge and fee recorded in the cost DB 23 is derived from the IP usage charge and the support cost recorded in the cost DB 22. The charge and fee recorded in the cost DB 23 are returned to the IP creator 1. The other aspects of the fifteenth embodiment are the same as the corresponding aspects of the first embodiment.

As described, according to the fifteenth embodiment, the same advantages available in the first embodiment are also available. In addition, the IP creator 1 is capable of collecting the support fee consistent with the level of support form the IP user 2.

Sixteenth Embodiment

The construction of the semiconductor intellectual property distribution system according to a sixteenth embodiment is the same as that of the first embodiment shown in FIG. 1. FIG. 15 shows a on-screen display presented when the IP user 2 refers to IP information related to an IP specification stored in the public IPDB 15. Three sets of IP of the same type are respectively associated with ranks A−, B and A+.

A description will now be given of the operation according to the sixteenth embodiment.

When the IP user accesses the public IPDB 15 in order to obtain IP information, the onscreen display as shown in FIG. 15 is presented. The semiconductor manufacturer 3 grades the performance of registered IP sets of the same type in accordance with the IP registering party (IP creator), usage record, contents of registered data, circuit scale, area and the like. The result of grading is made available to the IP user 2. The reference observed in grading may also be made known to the IP user 2. The other aspects of the sixteenth embodiment are the same as the corresponding aspects of the first embodiment.

As described, according to the sixteenth embodiment, the same advantages available in the first embodiment are also available. In addition, by enabling the semiconductor manufacturer 3 to grade registered IP sets of the same type and to make the result of grading known to the IP user 2, selection by the IP user 2 of an appropriate IP from the registered IP sets of the same type is facilitated. The IP creator 1 may compare the registered IP of its own creation with the IP of the same type registered by other creators. By improving the registered IP as required, the quality of IP is improved.

Seventeenth Embodiment

The construction of the semiconductor intellectual property distribution system according to a seventeenth embodiment is the same as the construction of the first embodiment shown in FIG. 1. FIG. 16 shows a on-screen display presented when the IP user 2 refers to IP information related to an IP specification stored in a public IPDB. In a similar configuration as the sixteenth embodiment shown in FIG. 15, three IP sets of the same type are respectively associated with ranks A−, B and A+. In addition to the contents shown in FIG. 15, the IP usage price is displayed.

A description will now be given of the operation according to the seventeenth embodiment.

When the IP user accesses the public IPDB 15 in order to obtain IP information, the onscreen display as shown in FIG. 16 is presented. In addition to the contents shown in FIG. 15, the semiconductor manufacturer 3 refers to the IP usage price in grading IP. The IP usage price is made known to the IP user 2. The semiconductor manufacturer 3 may introduce user-by-user IP usage price setting in accordance with the record of semiconductor manufacturing of the individual IP users 2. The other aspects of the operation according to the seventeenth embodiment are the same as the corresponding aspects of the sixteenth embodiment.

As described, according to the seventeenth embodiment, the same advantages available in the sixteenth embodiment are also available. In addition, since the semiconductor manufacturer 3 makes the IP usage prices known to the IP users 2, the IP users 2 could select a plurality of IP sets adapted for a purpose for efficient estimation of the semiconductor chip cost. Accordingly, a relatively early start of the design of a product is enabled. The semiconductor manufacturer 3 sets a price in accordance with the record of usage of IP by the IP user 2. Accordingly, the semiconductor manufacturer 3 is provided with a measure of expected increase in the IP usage charge collected.

Eighteenth Embodiment

FIG. 17 is a semiconductor intellectual property distribution system according to an eighteenth embodiment of the present invention. Referring to FIG. 17, the system includes a user design data of a semiconductor chip in which the IP made available to the IP user 2 is built, nonpublic information 42 such as layout information managed by the semiconductor manufacturer 3, a design apparatus 43 managed by the semiconductor manufacturer 3, a complete design data 44 in which the user design data 41 and the non-public information 42 are combined, and a firewall 34 prohibiting access from the IP user 2 to the design apparatus 43. The other aspects of the eighteenth embodiment are the same as the corresponding aspects of the first embodiment shown in FIG. 1.

A description will now be given of the operation according to the eighteenth embodiment.

In a similar configuration as the eleventh embodiment, the public IPDB 15 does not include layout information based on which IP is analyzed. The semiconductor manufacturer 3 separately manages the non-public information 42 such as the layout information. The IP user 2 obtains necessary IP information from the public IPDB 15 and produces the user design data 41 for a semiconductor chip in which the obtained IP is built. However, the user design data 41 produced by the IP user 2 is not complete data in that it does not include the layout information.

When the IP user 2 requests the semiconductor manufacturer 3 to produce a semiconductor chip, the IP user 2 transfers the user design data 41 to the design apparatus 43 managed by the semiconductor manufacturer 3. The design apparatus 43 combines the user design data 41 transferred from the IP use 2 and the non-public information 42 to produce the complete design data 44. The semiconductor manufacturer 3 manufactures the semiconductor chip based on the complete design data 44 thus produced. The other aspects of the eighteenth embodiment are the same as the corresponding aspects of the eleventh embodiment.

Thus, according to the eighteenth embodiment, the same advantages available in the eleventh embodiment are also available. In addition, the IP user 2 is capable of designing and developing a semiconductor chip in which IP is built even if layout information constituting IP information is not made public.

Nineteenth Embodiment

FIG. 18 is a semiconductor intellectual property distribution system according to a nineteenth embodiment of the present invention. Referring to FIG. 18, the system includes a control file 45 describing option settings and procedure of execution referred to when inspecting the design data, an inspection tool 46 provided in the design apparatus 43 to inspect the complete design data 44, inspection data 47 of the complete design data 44 inspected by the inspection tool 46, and public inspection data comprising a portion or the entirety of the inspection data 47. The other aspects of the construction are the same as the corresponding construction of the eighteenth embodiment shown in FIG. 17.

A description will now be given of the operation according to the nineteenth embodiment.

In a similar configuration as the eighteenth embodiment, the IP user 2 produces the user design data 41. The IP user 2 transfers the control file 45, in which is described the option settings and procedure of execution referred to when inspecting the complete design data 44, and the user design data 41 to the design apparatus 43 managed by the semiconductor manufacturer 3.

In a similar configuration as the eighteenth embodiment, the design apparatus 43 produces the complete design data 44. The inspection tool 46 uses the control file 45 transferred so as to inspect the complete design data 44 and produce the inspection data 47. A portion or the entirety of the inspection data thus produced is transferred as the public inspection data 48 to the IP user 2 and is made available therein. The IP user 2 refers to the public inspection data 48 transferred and corrects the use design data 41 if any malfunction is found. The corrected user design data 41 is transferred to the design apparatus 43 again so that the above process is repeated. The other aspects of the operation according to the nineteenth embodiment are the same as the corresponding aspects of the eighteenth embodiment.

As described, according to the nineteenth embodiment, the same advantages available in the eighteenth embodiment are available. In addition, layout information constituting IP information is not made public. The IP user 2 may not refer to the complete design data 44 directly. However, by transferring the control file 45 for inspection to the design apparatus 43 together with the use design data 41, the IP user 2 can control the inspection of the complete design data 44 so as to obtain a result of inspection. An advantage for the semiconductor manufacturer 3 is that it is not necessary to perform extra work of setting options and determining a procedure of execution. Thereby, the cost for inspection is reduced.

Twentieth Embodiment

FIG. 19 is a semiconductor intellectual property distribution system according to a twelfth embodiment of the present invention. Referring to FIG. 19, a search engine is provided to enable search in the public IPDB 15. The other aspects of the construction of the twentieth embodiment are the same as the corresponding construction of the first embodiment shown in FIG. 1.

A description will now be given of the operation of the twentieth embodiment.

The IP user 2 accesses the search engine 24 using a keyword for specifying required IP information. Performance or usage may also be specified as a search key. The search engine 24 searches the public IPDB 15 containing a large volume of IP information of similar types and the IP information that matched the specification is transferred from the public IPDB 15 to the IP user 2. The other aspects of the operation according to the twentieth embodiment are the same as the corresponding aspects of the first embodiment.

As described, according to the twentieth embodiment, the same advantages available in the first embodiment are also available. In addition, by accessing the search engine 24 specifying a keyword, performance, usage or the like for identifying IP information, the IP user 2 can efficiently obtain necessary IP information from the public IPDB 15 in which a large volume of IP information of similar types are stored.

Twenty-First Embodiment

FIG. 20 is a semiconductor intellectual property distribution system according to a twenty-first embodiment of the present invention. The construction of FIG. 20 is the same as the construction of FIG. 19. A difference from the twentieth embodiment is that the IP creator 1 uses the search engine 24.

A description will now be given of the operation according to the twenty-first embodiment.

The IP creator 1 accesses the search engine 24 using a keyword, performance or usage for specifying a target required IP specification. The search engine searches the public IPDB 15 containing a large volume of required IP information containing a large volume of required IP information of similar types. The required IP specification matching specification is transferred from the public IPDB 15 to the IP creator 1. The other aspects of the twenty-first embodiment are the same as the corresponding aspects of the first embodiment.

As described, according to the twenty-first embodiment, the same advantages available in the first embodiment are also available. In addition, by accessing the search engine 24 using a keyword, performance or usage for specifying a required IP specification, the target required IP specification is efficiently obtained from the public IPDB 15 containing a large volume of IP information of similar types.

The present invention is not limited to the above-described embodiments, and variations and modifications may be made without departing from the scope of the present invention.

What is claimed is:

1. A semiconductor intellectual property distribution system allowing a semiconductor manufacturer to register and manage intellectual property (IP) created by an IP creator and disclosing the registered and managed IP to an IP user engaged in designing and developing of a semiconductor chip using the IP, comprising:
a registration IP database registering an IP specification of the IP created by the IP creator;
a required IP registration database registering a required IP specification requested by the IP user;
a master database managing and storing an entirety of design information defined by the IP specification registered in said registration IP database and the required IP specification registered in said required IP registration database;
an evaluation database storing evaluation information related to the registered IP;
a first public database storing IP information and the required IP specification made available to the IP creator or the IP user, selected from the design information stored in said master database and the evaluation stored in said evaluation database, wherein
the semiconductor manufacturer returns a part of an IP usage charge collected from the IP user to the IP creator, when the IP stored in said first public database is used by the IP user.

2. The semiconductor intellectual property distribution system according to claim 1, wherein an identity of the IP creator, information on a semiconductor chip in which the created IP is built, and a portion of information related to creation and quality of the IP are not disclosed in accordance with designation by the IP creator registering the IP specification of the created IP in said registration IP database.

3. The semiconductor intellectual property distribution system according to claim 1, wherein the IP usage charge collected by the semiconductor manufacturer from the IP user includes an initial IP usage charge incurred at an initial stage of semiconductor chip development by the IP user.

4. The semiconductor intellectual property distribution system according to claim 1, wherein, in a case where the IP creator designs and develops a semiconductor chip using the IP of its own creation and commissions the semiconductor manufacturer to manufacture a prototype of the semiconductor chip and mass-produce the semiconductor chip, the semiconductor manufacturer deduces the IP usage charge returned to the IP creator via the IP user less a chip prototype manufacturing cost and a mass-production chip manufacturing cost and collects a resultant charge from the IP creator.

5. The semiconductor intellectual property distribution system according to claim 1, wherein, in a case where the IP user designs and develops a semiconductor chip using the IP and commissions the semiconductor manufacturer to manufacture a prototype of the semiconductor chip and mass-produce the semiconductor chip, the semiconductor manufacturer adds a chip prototype manufacturing cost and a mass-production chip manufacturing cost to the IP usage charge and collects a resultant charge from the IP user.

6. The semiconductor intellectual property distribution system according to claim 1, further comprising a second public database for the IP user, said second public database for the IP user storing the IP information related an external specification selected from the IP information stored in said first public database, and said second public database for the IP user being accessed by the IP user.

7. The semiconductor intellectual property distribution system according to claim 6, wherein said public database for the IP user enables the external specification to be downloaded instantaneously responsive to an-instruction from the IP user.

8. The semiconductor intellectual property distribution system according to claim 1, further comprising a second public database for the IP creator, said second public database for the IP creator storing the required IP specification selected from the required IP specification stored in said first public database, and said second public database being accessed by the IP user.

9. The semiconductor intellectual property distribution system according to claim 1, wherein, in said first public database, an identity of the registering IP creator, and information, registered by the IP creator, related to a semiconductor chip in which the IP is built, are not disclosed, while IP usage record is disclosed.

10. The semiconductor intellectual property distribution system according to claim 1, wherein an identity of the registering IP user, and information, registered by the IP user, related to a semiconductor chip in which the IP is built, are not disclosed in said first public database.

11. The semiconductor intellectual property distribution system according to claim 1, wherein layout information, based on which the IP is analyzable, is excluded from storage in said first public database.

12. The semiconductor intellectual property distribution system according to claim 1, further comprising a design apparatus for producing complete design data on a semiconductor chip, by combining user design data transferred from the IP user having built the IP, not including the layout information, in the semiconductor chip, and the layout information managed by the semiconductor manufacturer.

13. The semiconductor intellectual property distribution system according to claim 12, wherein said design apparatus inspects the complete design data using an inspection tool, based on a control file transferred from the IP user with the use design data and describing option settings and procedure of execution to be referred to in executing an inspection, and said design apparatus further transfers a portion or an entirety of inspection data obtained as a result of inspection to the IP user.

14. The semiconductor intellectual property distribution system according to claim 1, further comprising a support database accepting an inquiry as to lack or malfunction of the IP information placed by the IP user, wherein the semiconductor manufacturer refers to said support database so as to perform necessary actions responsive to lack or malfunction of the IP information.

15. The semiconductor intellectual property distribution system according to claim 14, wherein the semiconductor manufacturer collects from the IP user a support fee consistent with a level of support responsive to the lack or malfunction of the IP information.

16. The semiconductor intellectual property distribution system according to claim 1, further comprising a support database accepting an inquiry as to lack or malfunction of the IP information placed by the IP user, wherein the semiconductor manufacturer refers to said support database and instructs the IP creator to perform necessary actions responsive the lack or malfunction of IP information inquired of.

17. The semiconductor intellectual property distribution system according to claim 16, wherein said semiconductor manufacturer collects from the IP user a support fee consistent with a level of support responsive to the lack or malfunction of the IP information and returns the support fee to the IP creator.

18. The semiconductor intellectual property distribution system according to claim 1, wherein, in said first public database, a plurality of IP sets of a same type are graded so that a ranking is made available to the IP user.

19. The semiconductor intellectual property distribution system according to claim 18, wherein the plurality of IP sets of the same type are graded in accordance with a price at the time of using the IP so that a ranking is made available to the IP user.

20. The semiconductor intellectual property distribution system according to claim 1, further comprising a search engine for searching the IP information or the required IP specification stored in said first public database.

21. A semiconductor intellectual properly distribution method comprising the step of:
acquiring IP information from a public database storing IP information selected from design information stored in a master database and from evaluation stored in an evaluation database, the master database managing and storing an entirety of design information defined by an IP specification registered by an IP creator in a registration IP database and a required IP specification registered by an IP user in a required IP registration database, and the evaluation database storing evaluation information related to the design information and provided-by a semiconductor manufacturer, wherein
the IP user pays a usage charge to the semiconductor manufacturer for the use of the IP information as a result of designing a semiconductor, and the semiconductor manufacturer returns a part of the usage charge to the IP creator.
